(19) United States
(12) Patent Application Publication
(10) Pub. No.: US 2025/0377319 A1
(43) Pub. Date: Dec. 11, 2025

(54) OPEN-AIR, VARIABLE-TEMPERATURE X-RAY DIFFRACTOMETER

(71) Applicant: KING FAHD UNIVERSITY OF PETROLEUM AND MINERALS, Dhahran (SA)

(72) Inventor: Khan ALAM, Dhahran (SA)

(73) Assignee: KING FAHD UNIVERSITY OF PETROLEUM AND MINERALS, Dhahran (SA)

(21) Appl. No.: 18/737,415

(22) Filed: Jun. 7, 2024

(51) Int. Cl. G01N 23/20033; G01K 13/00; G01N 23/207; G01N 25/12; G01N 25/16

(52) U.S. Cl. CPC G01N 23/20033; G01K 13/006; G01N 23/207; G01K 2203/00; G01N 25/12; G01N 25/16; G01N 2223/3103; G01N 2223/61

(57) ABSTRACT

A method of X-ray characterization includes cooling a sample by delivering liquid nitrogen via a pipe to a sample stage of the X-ray diffractometer. The liquid nitrogen is discharged from the pipe to form a coolant stream. The pipe has an outlet to orient a flow of the coolant stream at the sample on the sample stage. The sample includes a substrate and a thin film formed on the substrate. During the cooling, diffraction data of the thin film and diffraction data of the substrate are collected by a detector of the X-ray diffractometer. A temperature of the thin film is determined based on the diffraction data of the substrate and thermal behavior of the substrate as a function of temperature. The thermal behavior of the substrate includes thermal expansion, thermal contraction or both.

### STATEMENT REGARDING PRIOR DISCLOSURE BY THE INVENTORS

Aspects of the present disclosure are published in “Study of the structure, structural transition, interface model, and magnetic moments of CrN grown on MgO(001) by molecular beam epitaxy”, J. Vac. Sci. Technol. A 41, 053411 (2023), which is incorporated herein by reference in its entirety.

### STATEMENT OF ACKNOWLEDGEMENT

This work was supported by the Interdisciplinary Research Center for Sustainable Energy Systems of King Fahd University of Petroleum and Minerals, Dhahran, Saudi Arabia under grant No. INRE2216.

### BACKGROUND

### Technical Field

The present disclosure is directed to the field of X-ray characterization and analysis. Specifically, the present disclosure relates to a method and an apparatus for X-ray characterization, particularly involving X-ray diffractometry in open-air conditions, for example to investigate structural changes and phase transitions of materials under varying thermal conditions.

### Description Of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In the field of material science, studying the structural properties of materials under varying temperature conditions is required for understanding their phase transitions and other thermal behaviors. The phenomenon of materials undergoing contraction or expansion in response to temperature changes has always been a research subject of interest. At the atomic scale, the behavior of various materials becomes intriguing. In some cases, the distance between atoms follows a linear trend of either increasing or decreasing as temperature shifts. However, in contrast, some materials exhibit more complex behaviors, showcasing non-linear contractions or expansions as temperature varies. Going beyond these fundamental thermal responses, some materials unveil another layer of complexity through phase transitions. These transitions encompass a spectrum of changes, including alterations in structural arrangement, electronic properties, and even magnetic characteristics of the material. In certain materials, these transitions are not isolated events; they can be interlinked and correlated. A classic example of such interplay can be observed in the case of chromium nitride.

X-ray diffraction is a widely used technique for analyzing these changes because it allows researchers to determine the crystal structures of various materials accurately. Typically, an X-ray diffractometer is used to emit X-ray beams at the sample, and the detector captures the diffraction patterns, revealing information about the lattice constants and crystal phases. Such analyses are often conducted at room temperature or in low-temperature environments, requiring sophisticated temperature control systems. Despite the effectiveness of X-ray diffraction, conventional X-ray diffractometers present challenges due to the high cost and complexity associated with vacuum systems, temperature sensors, and controllers. Maintaining a controlled temperature environment is necessary for accurate data collection, but vacuum setups inevitably add significant extra expense. Furthermore, temperature sensors and controllers may need to be calibrated carefully to avoid errors that could lead to inaccurate temperature readings and unreliable phase transition analysis.

Conventional solutions have employed various temperature control mechanisms and vacuum systems. These solutions often require specialized equipment and complex calibration procedures. Some systems use specialized temperature controllers to stabilize temperature of the sample, while others implement vacuum systems to achieve ultra-low temperatures. Although they can provide precise temperature control, they demand significant investment and technical expertise, limiting the accessibility of such studies. For instance, vacuum systems are costly to install and maintain and require continuous monitoring to prevent contamination. Further, temperature sensors and controllers are sensitive to calibration errors, potentially affecting the accuracy of temperature readings. Additionally, switching between heating and cooling modes requires a recalibration of the entire system, making it challenging to conduct studies that involve both processes.

EP 4083597A1 discloses a device/method for cooling down a (bio) sample and study its behavior under a microscope. Liquid nitrogen can be supplied from a pressure tank to the sample. EP 3945309A1 discloses a method for characterizing a stress variation in a thin film. The disclosed method applies a constant temperature capable of causing the thin film to pass from a first state to a second state, and then determines of the stress variation in the film by measuring the width at mid-height β CR of the rocking curve by X-ray diffraction. CN 206223698U discloses an X-ray diffraction device. This reference describes using liquid nitrogen for controlling the temperature, and a thermostat is used. Additionally, the sample is under vacuum.

Each of the aforementioned references suffers from one or more drawbacks hindering their adoption. For instance, none of the aforementioned references describes X-ray diffraction for studying the structural properties of materials under varying temperature conditions, and with a sample under atmospheric pressure and no vacuum condition, and no temperature sensor or controller being used for monitoring the temperature. Accordingly, it is one object of the present disclosure to provide methods and systems for conducting X-ray diffraction at atmospheric pressure without using vacuum systems, temperature sensors, or controllers. Such an approach provides a practical solution to the limitations of existing X-ray diffraction techniques, enabling reliable phase transition analysis while minimizing complexity and cost.

SUMMARY

In an exemplary embodiment, a method of X-ray characterization is described. The method includes cooling a sample by delivering liquid nitrogen via a pipe to a sample stage of an X-ray diffractometer. The liquid nitrogen is discharged from the pipe to form a coolant stream. The pipe has an outlet to orient a flow of the coolant stream at the sample on the sample stage. The sample includes a substrate and a thin film formed on the substrate. During the cooling, diffraction data of the thin film and diffraction data of the substrate are collected by a detector of the X-ray diffractometer. A temperature of the thin film is determined based on the diffraction data of the substrate and thermal behavior of the substrate as a function of temperature. The thermal behavior of the substrate includes thermal expansion, thermal contraction or both.

In some embodiments, a phase transition of the thin film is identified based on the diffraction data of the thin film and the temperature of the thin film.

In some embodiments, the sample stage is at an atmospheric pressure.

In some embodiments, the X-ray diffractometer includes no temperature sensor that is configured to measure the temperature of the thin film or a temperature of the substrate.

In some embodiments, the X-ray diffractometer includes no temperature controller that is configured to maintain the sample stage or the sample at a specific temperature.

In some embodiments, the substrate has a linear thermal expansion behavior as a function of temperature.

In some embodiments, the substrate includes magnesium oxide (MgO).

In some embodiments, the thin film has a linear thermal expansion behavior as a function of temperature.

In some embodiments, the thin film includes chromium nitride (CrN).

In some embodiments, during the cooling, the sample is cooled by the coolant stream to a first temperature of 203 K to 273.15 K.

In some embodiments, the method further includes warming the sample to a second temperature above the first temperature by reducing a flow rate of the coolant stream delivered to the sample.

In some embodiments, the method further includes determining a temperature of the substrate by T=T₀+(a−a₀)/(a₀α₁). Herein, T is a real-time temperature of the substrate, T₀ is an initial temperature of the substrate before the coolant stream is formed, a is a real-time lattice constant of the substrate, a₀ is an initial lattice constant of the substrate before the coolant stream is formed, and α₁ is a thermal expansion coefficient of the substrate.

In some embodiments, the method further includes determining the temperature of the thin film to be T.

In some embodiments, the method further includes analyzing thermal behavior of the thin film based on the temperature of the thin film. The thermal behavior of the thin film includes at least one selected from the group consisting of thermal expansion, thermal contraction and structural phase transition.

In some embodiments, the substrate includes MgO, and the thin film includes chromium nitride CrN. The method further includes analyzing an in-plane lattice constant of CrN, an out-of-plane lattice constant of CrN or both.

In some embodiments, T₀ is about 293 K, a₀ is about 4.21 Å, and α₁ is about 9.84×10⁻⁶ K⁻¹.

In some embodiments, α₁ has a constant value with regard to temperature.

In another exemplary embodiment, an X-ray diffractometer is described. The X-ray diffractometer includes a sample stage configured to receive a sample. The X-ray diffractometer further includes an X-ray source configured to emit an X-ray beam directed at the sample. The X-ray diffractometer further includes a detector configured to receive a diffraction spectrum of the sample. The X-ray diffractometer further includes a pipe configured to deliver liquid nitrogen which is discharged from the pipe to form a coolant stream. The pipe has an outlet to orient a flow of the coolant stream at the sample on the sample stage. The X-ray diffractometer further includes a base container configured to collect ice and water from the sample stage. Herein, the X-ray diffractometer includes no vacuum system configured to subject the sample stage to a vacuum condition so that the sample stage is at an atmospheric pressure. Further, the X-ray diffractometer includes no temperature sensor configured to measure temperature. Furthermore, the X-ray diffractometer includes no temperature controller configured to maintain the sample stage or the sample at a specific temperature.

In some embodiments, the X-ray diffractometer further includes a controller configured to determine a temperature of a thin film of the sample based on diffraction data of a substrate of the sample and thermal behavior of the substrate as a function of temperature, the thermal behavior of the substrate including thermal expansion, thermal contraction or both, the thin film formed over the substrate.

In some embodiments, the controller is configured to determine a temperature of the substrate by T=T₀+(a−a₀)/(a₀α₁) and determine the temperature of the thin film to be T. Herein, T is a real-time temperature of the substrate, T₀ is an initial temperature of the substrate before the coolant stream is formed, a is a real-time lattice constant of the substrate, a₀ is an initial lattice constant of the substrate before the coolant stream is formed, and α₁ is a thermal expansion coefficient of the substrate.

In some embodiments, the X-ray diffractometer further includes a water-resistant material covering the X-ray source and the detector.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary flowchart of a method of X-ray characterization, according to certain embodiments.

FIG. 2 is a diagrammatic representation of an X-ray diffractometer, according to certain embodiments.

FIG. 3 is a schematic diagram of a setup for implementation of the X-ray diffractometer for analyzing diffraction data, according to certain embodiments.

FIG. 4 is an exemplary illustration of X-ray diffraction pattern of a sample (S45), with inset showing a zoomed-in view of the 002 peaks of MgO and CrN, according to certain embodiments.

FIG. 5A is an exemplary scanning transmission electron microscopy (STEM) image of CrN/MgO(001) bilayer thin film, according to certain embodiments.

FIG. 5B is an exemplary atomically resolved image of the CrN/MgO interface, according to certain embodiments.

FIG. 5C is an exemplary graph of in-plane interplanar spacing versus a number of layers with respect to the interface, according to certain embodiments.

FIG. 5D is an exemplary graph of out-of-plane interplanar spacing versus the number of layers with respect to the interface, according to certain embodiments.

FIG. 5E is an exemplary atomically resolved STEM image of the interface showing (100)_{CrN} and (100)_{MgO} lattice planes, according to certain embodiments.

FIG. 5F is an exemplary related model for the CrN/MgO interface, according to certain embodiments.

FIG. 6A is an exemplary graph of X-ray diffraction (XRD) spectra of 002 peak of MgO and CrN in a range of temperature from 293 K to 203 K, according to certain embodiments.

FIG. 6B is an exemplary plot of CrN thin film going through structural phase transition at 256 K, according to certain embodiments.

FIG. 7 is an illustration of a non-limiting example of details of computing hardware used in the computing system, according to certain embodiments.

FIG. 8 is an exemplary schematic diagram of a data processing system used within the computing system, according to certain embodiments.

FIG. 9 is an exemplary schematic diagram of a processor used with the computing system, according to certain embodiments.

FIG. 10 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a method and an apparatus for X-ray characterization, enabling efficient study of phase transitions and thermal behaviors of materials. The present disclosure describes the use of diffraction data of a substrate to determine temperature of the material formed as a thin film on the substrate, eliminating the need for expensive vacuum systems and temperature controllers traditionally used in X-ray diffractometers.

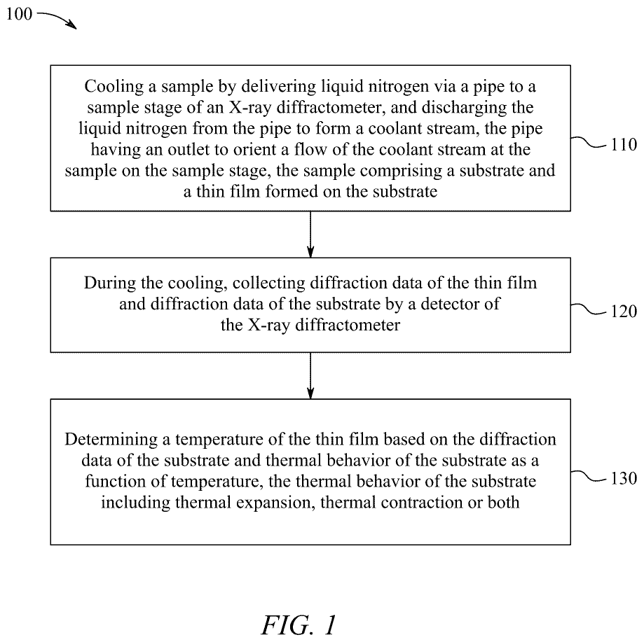

Referring to FIG. 1, illustrated is an exemplary flowchart of a method (as represented by reference numeral 100) of X-ray characterization. The method 100 is configured to analyze the thermal behaviors of a sample that is the form of one or more thin films, preferably a thin film, formed on a substrate. The film can be crystalline (e.g. single crystalline or polycrystalline) or non-crystalline. The method 100 relies on the thermal expansion or contraction behavior of the substrate to determine the real-time temperature of the sample. The method 100 utilizes mathematical techniques that relates diffraction data of the substrate to its temperature, to eliminate the need for temperature sensors or controllers, simplifying the setup while ensuring accurate temperature determination. By relying on substrate data to determine temperature of the thin film, the method 100 reduces the complexity typically associated with X-ray diffractometry while providing accurate and reproducible results. Thereby, the method 100 of X-ray characterization, as per the present disclosure, provides a simplified and effective approach for analyzing thermal behaviors and phase transitions in thin films.

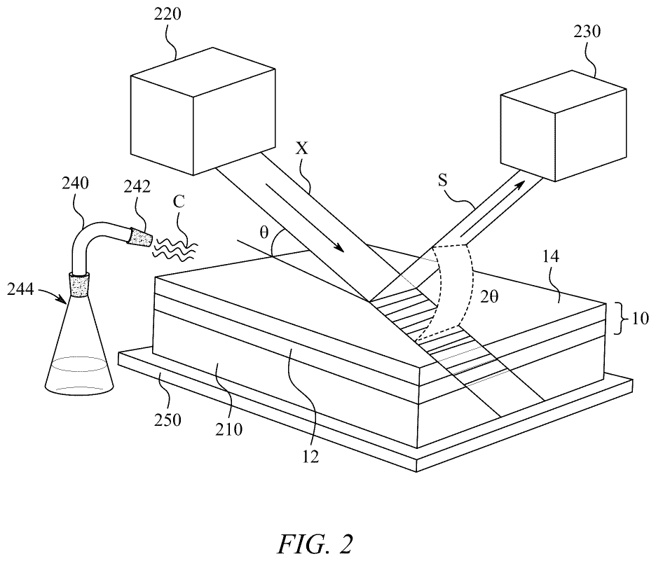

The method 100 implements an X-ray diffractometer 200 (as diagrammatically illustrated in FIG. 2). The X-ray diffractometer 200 is configured to analyze the structural and thermal behaviors of a sample 10 that includes a substrate 12 with a thin film 14 formed on the substrate 12. The method 100 employs the X-ray diffractometer 200 to efficiently analyze the thermal behaviors and phase transitions of the thin film 14 without requiring expensive and complicated set-up, providing a practical and cost-effective solution for material characterization. The X-ray diffractometer 200 includes multiple components working together to achieve efficient sample characterization. As illustrated in FIG. 2, the X-ray diffractometer 200 includes a sample stage 210 configured to receive the sample 10. The X-ray diffractometer 200 also includes an X-ray source 220 configured to emit an X-ray beam ‘X’ directed at the sample 10. The X-ray diffractometer 200 further includes a detector 230 configured to receive a diffraction spectrum ‘S’ of the sample 10. The X-ray diffractometer 200 further includes a pipe 240 configured to deliver liquid nitrogen which is discharged from the pipe 240 to form a coolant stream ‘C’. The X-ray diffractometer 200 further includes a base container 250 configured to collect ice and water from the sample stage 210.

For illustrative purposes of the present disclosure, the substrate 12 has a linear thermal expansion behavior as a function of temperature. This means that changes in lattice constant of the substrate 12 occur predictably and proportionally with variations in temperature. This consistent thermal behavior allows for accurate determination of temperature of the substrate 12 by comparing real-time changes in lattice constants of the substrate 12 to its known thermal expansion coefficient (of the substrate 12). In an example embodiment, the substrate 12 includes magnesium oxide (MgO). The MgO material is known for its linear thermal properties. Such predictable response of MgO material to temperature changes makes it suitable for monitoring and measuring temperature shifts in the X-ray characterization process. Therefore, the linear thermal expansion behavior of magnesium oxide, when used as the substrate 12, provide a reliable basis for determining temperature of the thin film 14 during cooling or warming cycles, enabling accurate thermal analysis and phase transition characterization.

Furthermore, for illustrative purposes of the present disclosure, the thin film 14 has a linear thermal expansion behavior as a function of temperature. This means that changes in lattice constant of the thin film 14 occur proportionally with temperature variations. This predictable thermal expansion allows for accurate analysis of structural changes and behavior of the thin film 14 in response to cooling or warming cycles. In an example embodiment, the thin film 14 includes chromium nitride (CrN). The CrN material is of interest for its magnetic and structural properties, particularly around its phase transition temperature. This characteristic enables monitoring of the thermal behaviors and phase transitions of CrN through X-ray diffraction analysis. In general, the linear thermal expansion behavior of CrN, combined with its thermal properties, allows for reliably determining temperature and analyzing structural changes in the thin film 14, when formed on the substrate 12. Film thickness of the thin film 14 is not particularly limited. For instance, the thin film 14 can have a film thickness ranging from 1 nm to 10 μm, e.g., 1 nm, 5 nm, 10 nm, 50 nm, 100 nm, 500 nm, 1 μm, 5 μm, 10 μm, or any values therebetween. In this example, the thin film 14 is formed directly on the substrate 12 with no other films in between. In other examples, one or more other films (e.g., metals and/or dielectrics) may be formed between the thin film 14 and the substrate 12.

In the X-ray diffractometer 200, the sample stage 210 is designed to securely hold the sample 10 during processing, ensuring that the sample 10 remains stable throughout the collection of diffraction data. In some examples, the sample stage 210 may utilize a locking mechanism or the like to securely hold the sample 10. The sample stage 210 maintains the sample 10 in a position to allow for accurate measurement of diffraction data for both the substrate 12 and the thin film 14 formed on the substrate 12. The sample stage 210 is positioned such that the X-ray source 220 can emit the X-ray beam ‘X’ directly at the sample 10 (at an angle θ), while the detector 230 is aligned to capture the resulting diffraction spectrum ‘S’ (at an angle 2θ), allowing data collection during cooling or warming cycles. The sample stage 210 is also configured to receive the coolant stream ‘C’ stream directed at the sample 10, ensuring that the coolant stream ‘C’ effectively cools the sample 10 to the desired temperature range. Note that FIG. 2 and the remaining figures in the present disclosure are not necessarily drawn to scale. For instance, while the sample 10 is shown to be as big as the sample stage 210 and bigger than the X-ray source 220 and the detector 230, it should be understood that the sample 10 may have any suitable size, preferably smaller than the sample stage 210, the X-ray source 220 and the detector 230. In a non-limiting example, the sample 10 can have a lateral dimension of 0.5 cm to 10 cm, e.g., 0.5 cm, 1 cm, 2 cm, 1 inch, 5 cm, 2 inches, 8 cm, 10 cm or any values therebetween.

The X-ray source 220 is positioned such that the emitted X-ray beam ‘X’ aligns with the sample 10 on the sample stage 210. This alignment enables the X-ray beam ‘X’ to interact with the sample 10, e.g., cooling down the thin film 14 formed on the substrate 12 (as depicted in FIG. 2) and generating the diffraction spectrum ‘S’ that represents internal crystalline structure of the sample 10. The X-ray source 220 may be configured to emit the X-ray beam ‘X’ with a wavelength suitable for capturing diffraction data that can determine structural changes in the sample 10. The emitted X-ray beam ‘X’ passes through the sample 10 to enable the detector 230 to capture the diffraction spectrum ‘S’ for both the thin film 14 and the substrate 12. This configuration allows the X-ray diffractometer 200 to collect data which may then be analyzed to determine the thermal behavior of the sample 10, including phase transitions and changes in lattice constants.

In the X-ray diffractometer 200, the detector 230 may be positioned directly opposite the X-ray source 220. The detector 230 is aligned to capture the diffraction spectrum ‘S’ generated when the emitted X-ray beam ‘X’ interacts with the sample 10 on the sample stage 210. The alignment of the detector 230 ensures that the collected diffraction spectrum ‘S’ represents the interaction between the X-ray beam ‘X’ and the sample 10, providing data for subsequent processing and analysis. As the X-ray beam ‘X’ penetrates through the thin film 14 and the substrate 12, the detector 230 collects the resulting diffraction spectrum ‘S’ that provides data on internal crystalline structure of the sample 10. The detector 230 is specifically designed to identify changes in the diffraction spectrum ‘S’ corresponding to the thermal behaviors of the thin film 14 and the substrate 12, such as shifts in the lattice constants that occur due to cooling or warming of the sample 10.

Further, as mentioned, the pipe 240 is configured to deliver the liquid nitrogen, which is discharged from the pipe 240 to form the coolant stream ‘C’. As the coolant stream ‘C’ flows over the sample 10, the temperature decreases to a level suitable for thermal behavior analysis using X-ray diffraction. The pipe 240 has an outlet 242 designed to orient the flow of the coolant stream ‘C’ directly at the sample 10 on the sample stage 210. In one embodiment, the outlet 242 of the pipe 240 is positioned in a way that allows the coolant stream ‘C’ to cover the sample 10 uniformly, ensuring uniform cooling/warming of the sample 10. In another embodiment, the sample 10 is relatively large for the outlet 242 of the pipe 10 so the sample 10 is not cooled uniformly across its entirety. However, a portion of the sample 10, depending on the size of the outlet 242 of the pipe 10, can be cooled/warmed uniformly and studied by X-ray diffraction. The coolant stream ‘C’, directed from the outlet 242 of the pipe 240 to the sample 10, helps reduce the temperature of the substrate 12 and the thin film 14 thereon. Such a configuration further allows the sample 10 to warm gradually when the flow rate is reduced. This control enables effective and proper X-ray characterization structural and thermal properties of the sample 10. For present purposes, the pipe 240 may be a flexible pipe to allow for directing the liquid nitrogen coolant stream ‘C’ to the sample stage 210. Also, in the illustrated example, the pipe 240 and the corresponding outlet 242 are depicted to be receive the liquid nitrogen from a container (as represented by reference numeral 244); however, it may be appreciated that this set-up may take any other suitable form without departing from the scope and the spirit of the present disclosure.

Further, in the X-ray diffractometer 200, the base container 250 is configured to collect any condensation or byproducts resulting from the cooling process. As the liquid nitrogen coolant stream ‘C’ cools the sample 10, condensation in the form of ice and water may accumulate around the sample stage 210 due to atmospheric moisture. The base container 250, positioned below the sample stage 210 (as illustrated in FIG. 2), ensures that this condensation is collected, preventing ice and water from interfering with the operation of the X-ray diffractometer 200. By capturing the condensation, the base container 250 also helps maintain a clean environment around the sample stage 210. This allows the X-ray diffractometer to consistently obtain accurate diffraction data of the substrate 12 and the thin film 14, contributing to precise analysis of thermal behaviors and phase transitions in the sample 10.

In some embodiments, the X-ray diffractometer 200 includes a water-resistant material (not shown) covering the X-ray source 220 and the detector 230. It may be appreciated that the liquid nitrogen coolant stream ‘C’ directed at the sample 10 may generate condensation (for example, in the form of ice/water) around the sample stage 210. The water-resistant material acts as a protective covering which prevents condensation or moisture accumulation on these components during the cooling and warming processes. That is, the water-resistant material ensures that the X-ray source 220 and the detector 230 remain unaffected by the moisture. The water-resistant material based protective covering also reduces the risk of equipment damage and data interference, allowing the X-ray diffractometer 200 to operate consistently and collect the diffraction data without external contamination. Thereby, the water-resistant material helps maintain the accuracy and reliability of the X-ray source 220 for emitting the X-ray beam ‘X’ towards the sample 10 and the detector 230 to collect the diffraction spectrum ‘S’, in the X-ray diffractometer 200.

In a preferred embodiment of the invention the base container 250 is integrated with the outlet 242. In order to maintain a stable sample temperature and to permit controllable rapidly temperature changes, the coolant stream C is directed onto the sample 10 from multiple points. The liquid nitrogen pipe 240 preferably enters a coolant dispersal system functioning as a nozzle/outlet. The cooler dispersal system includes the base container 250 and four walls which extend vertically from the base container 250 to a height above the sample 10, film and substrate layers (e.g. 12 and 14). The walls are insulated on an outside surface and are hollow cavity with a plurality of ejection orifices inner surface disposed on an inner surface directed to the center of the film 14 and/or the center of the substrate 12. The coolant stream C is injected into the hollow walls at an inlet point on a top surface of each edge of each wall and is rapidly dispersed in the cavity of each wall to exit through the plurality of orifices. The coolant stream C then exits by overflowing a partial enclosure formed by the base container 250 and the four walls. The plurality of orifices of each wall preferably includes at least two rows of orifices, a first row of orifices proximal to a bottom edge of each wall and a top row of orifices proximal and above the upper surface of the film 14 and the substrate 12. Dispersal of the coolant stream C through this system ensures homogeneous cooling of the substrate 12, and the film 14 (and optionally the sample stage 210). The insulated exterior portions of each wall and the base container 250 serve to provide a controllable and stable temperature environment.

In embodiments of the present disclosure, the sample stage 210 is at an atmospheric pressure. Maintaining atmospheric pressure at the sample stage 210 simplifies the overall configuration of the X-ray diffractometer 200, reducing the cost and technical challenges often associated with vacuum systems. In the present embodiments, the X-ray diffractometer 200 optionally includes no vacuum system configured to subject the sample stage 210 to a vacuum condition so that the sample stage 210 is at the atmospheric pressure. By operating in an open-air environment, the sample stage 210 ensures that the sample 10 can be analyzed efficiently using the liquid nitrogen coolant stream ‘C’, providing a consistent temperature reduction suitable for studying phase transitions and other thermal behaviors in the thin film 14 and the substrate 12. Such a configuration eliminates the need for the vacuum system and the complexity typically associated with maintaining a vacuum condition (including re-calibration), and thus simplifies the configuration and reduces cost of operating the X-ray diffractometer 200.

Further, in the present embodiments, the X-ray diffractometer 200 optionally includes no temperature sensor configured to measure temperature. Specifically, the X-ray diffractometer 200 includes no temperature sensor that is configured to measure the temperature of the thin film 14 or a temperature of the substrate 12. Instead of relying on traditional temperature sensors, the X-ray diffractometer 200 determines the temperature by analyzing the diffraction spectrum ‘S’ of the substrate 12. The linear thermal expansion behavior of the substrate 12 (as discussed) is used to correlate the changes in lattice constants with specific temperature shifts. This eliminates the need for separate temperature sensors and simplifies the design while maintaining accurate temperature determination. Furthermore, in the present embodiments, the X-ray diffractometer 200 includes no temperature controller that is configured to maintain the sample stage or the sample 10 at a specific temperature. As discussed, the X-ray diffractometer 200 utilizes the liquid nitrogen coolant stream ‘C’ directed at the sample 10 to cool it to the desired temperature range. Also, the reduction of the coolant flow during warming gradually increases the sample 10 temperature. This approach enables the X-ray diffractometer 200 to provide effective cooling and gradual warming while ensuring reproducible temperature measurement through real-time diffraction data analysis, without the need for specialized or separate temperature control mechanisms. It may be appreciated that the absence of a temperature controller helps in simplifying the design of the X-ray diffractometer 200, reducing complexity and potential calibration challenges.

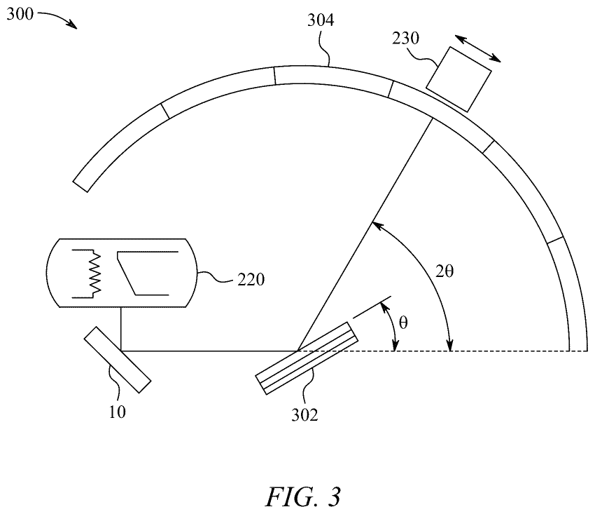

FIG. 3 illustrates a schematic diagram of a setup (as represented by reference numeral 300) for implementation of the X-ray diffractometer 200 for analyzing diffraction data. Herein, the X-ray source 220 emits an X-ray beam that is directed toward the sample 10. The X-ray beam then interacts with the sample 10 and an analyzing crystal 302, creating a diffraction pattern that is collected by the detector 230. In particular, the emitted X-ray beam', incident at an angle (θ), is diffracted by the sample 10 and the analyzing crystal 302, resulting in a diffraction angle (2θ) recorded by the detector 230. The detector 230 is mounted on a goniometer 304 that allows it to move in a circular arc around the sample 10 to capture the diffraction data at different angles. The setup 300 enables the X-ray diffractometer 200 to accurately determine temperature of the sample by analyzing changes in the diffraction patterns, providing information about the thermal behavior of constituents of the sample.

Referring back to FIG. 1, illustrated are steps involved in the method 100 of X-ray characterization. These steps are only illustrative, and other alternatives may be considered where one or more steps are added, one or more steps are removed, or one or more steps are provided in a different sequence without departing from the scope of the present disclosure. As discussed, the method 100 implements the X-ray diffractometer 200. Various variants disclosed above, with respect to the aforementioned X-ray diffractometer 200 apply mutatis mutandis to the present method 100.

At step 110, the method 100 includes cooling the sample 10. Cooling the sample 10 involves delivering the liquid nitrogen via the pipe 240 to the sample stage 210 of the X-ray diffractometer 200, and discharging the liquid nitrogen from the pipe 240 to form the coolant stream ‘C’ directed at the sample stage 210. The pipe 240 has the outlet 242 that orients the flow of the coolant stream ‘C’ directly at the sample 10 on the sample stage 210. The sample 10 includes the substrate 12 with the thin film 14 formed on the substrate 12. Herein, the liquid nitrogen coolant stream ‘C’ is transported through the pipe 240 to the outlet 242, which aims the coolant stream ‘C’ at the sample 10 placed on the sample stage 210. In some embodiments, the coolant stream ‘C’ reaches the sample 10 uniformly, providing steady and reproducible cooling across the surface of the sample 10. The coolant stream ‘C’ reduces the temperature of the sample 10 by surrounding the sample stage 210 with the liquid nitrogen. As the coolant stream ‘C’ contacts the sample stage 210, the substrate 12 and the thin film 14 experience thermal contraction. The linear thermal expansion behavior of both the substrate 12 and the thin film 14 allows temperature determination based on changes in their lattice constants. This cooling method enables control over the temperature of the sample 10 without requiring a vacuum system or temperature sensors, providing a practical approach for studying thermal behaviors, including phase transitions, using X-ray diffraction analysis.

In present embodiments, during the cooling, the sample 10 is cooled by the coolant stream ‘C’ to a first temperature of 150K to 273.15 K, e.g. 150K, 170K, 190K, 200K, 203 K, 210K, 220 K, 240K, 250K, 260K, 273.15K or any values therebetween. As discussed, this process is achieved by directing the steady flow of liquid nitrogen, as the coolant stream ‘C’, through the pipe 240 that has the outlet 242 positioned to aim the coolant stream ‘C’ directly at the sample 10 on the sample stage 210 of the X-ray diffractometer 200. The coolant stream ‘C’ can surround the sample 10 with nitrogen vapor, causing the temperature of the substrate 12 and the thin film 14 formed on the substrate 12 to drop. The range of 203 K to 273.15 K encompasses the temperatures required to observe significant structural changes or phase transitions in certain materials, including chromium nitride (CrN). The temperature reduction achieved with the coolant stream allows researchers to investigate thermal contraction and other behaviors of the sample 10, providing reliable data through X-ray diffraction patterns.

The method 100 may further involve warming the sample 10 to a second temperature above the first temperature by reducing a flow rate of the coolant stream ‘C’ delivered to the sample 10. As the flow of liquid nitrogen through the pipe 240 decreases, the amount of the coolant stream ‘C’ is therefore reduced, allowing the sample 10 to gradually warm. This controlled warming ensures that the sample 10 reaches a stable and consistent second temperature above the first temperature range of 203 K to 273.15 K. It may be appreciated that this process allows the sample 10 to warm uniformly, ensuring that the structural changes or phase transitions occurring during the temperature increase can be monitored through X-ray diffraction data. The gradual warming cycle enables repeated analysis and allows researchers to observe how the substrate 12 and the thin film 14 respond to temperature changes.

At step 120, the method 100 includes, during the cooling, collecting diffraction data of the thin film 14 and diffraction data of the substrate 12 by the detector 230 of the X-ray diffractometer 200. For this purpose, as the coolant stream ‘C’ cools the sample 10 on the sample stage 210, the X-ray source 220 may continuously emit the X-ray beam ‘X’ directed at the thin film 14 formed on the substrate 12. The detector 230, then, captures the resulting diffraction spectrum ‘S’ produced as the X-ray beam ‘X’ interacts with the sample 10. By continuously monitoring the diffraction spectrum ‘S’ throughout the cooling and the warming processes, the detector 230 enables analysis of the thin film 14 and the substrate 12 response to temperature changes, including any phase transitions or structural shifts that may occur. Specifically, the collected diffraction data allow researchers to determine temperature changes in the substrate 12 and correlate those with thermal behaviors in the thin film 14.

At step 130, the method 100 includes determining a temperature of the thin film 14 based on the diffraction data of the substrate 12 and thermal behavior of the substrate 12 as a function of temperature. The thermal behavior of the substrate 12 includes thermal expansion, thermal contraction or both. By analyzing changes in the diffraction spectrum ‘S’ of the substrate 12 during the cooling and warming cycles, the method 100 leverages the linear thermal expansion behavior of the substrate 12 to determine its temperature. Using this predictable behavior, the method 100 calculates the temperature of the substrate by comparing changes in its lattice constant with known thermal expansion coefficients. This calculated temperature is then used to determine the temperature of the thin film 14 because the thin film 14 is formed directly on the substrate 12, and the thermal behavior of the substrate 12 directly correlates with that of the thin film 14. This approach eliminates the need for direct temperature sensors for the thin film 14 itself. Instead, by relying on diffraction data and thermal characteristics of the substrate 12, the method 100 enables determination of temperature of the thin film 14, which provides insights into structural and thermal changes in the thin film during the cooling and warming cycles.

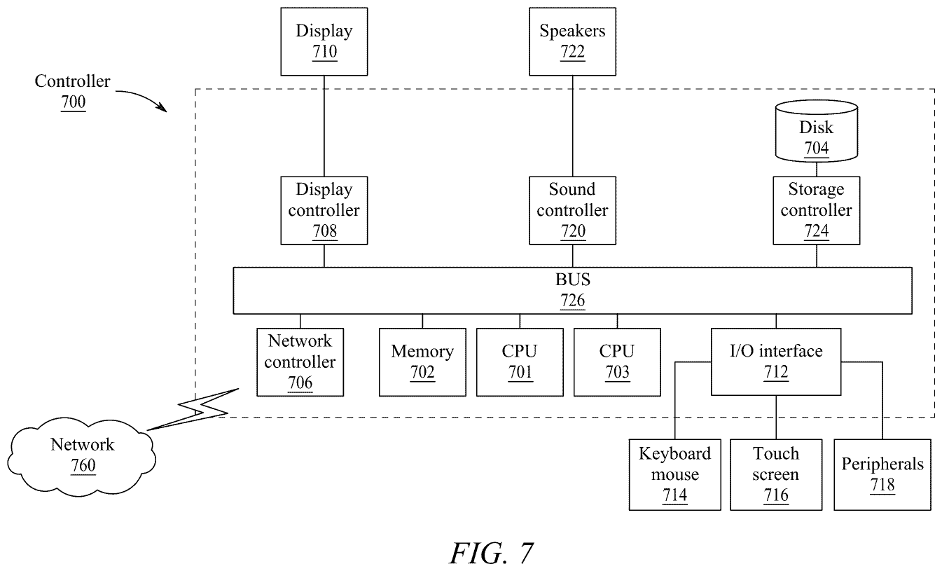

For present purposes, the X-ray diffractometer 200 may include a controller (not shown in FIG. 2) configured to determine the temperature of the thin film 14 of the sample 10 based on diffraction data collected from the substrate 12 of the sample 10 and the thermal behavior of the substrate 12 as a function of temperature. The controller analyzes the diffraction data of the substrate 12, which shows predictable thermal expansion or contraction behavior. By monitoring changes in lattice constant of the substrate 12, the controller calculates temperature of the substrate 12 using a known mathematical formula that accounts for initial temperature and thermal expansion coefficient of the substrate 12. The controller then correlates temperature of the substrate 12 with temperature of the thin film 14, assuming the thermal behavior of the substrate 12 directly correlates with that of the thin film 14. The detailed configuration of the controller, as implemented by the X-ray diffractometer 200, has been described later in the description with reference to FIGS. 7-10.

As discussed in the preceding paragraphs, the temperature of the substrate 12 is calculated using known mathematical formula(es). In an example embodiment, the method 100 involves determining a temperature of the substrate by T=T₀+(a−a₀)/(a₀α₁), wherein T is a real-time temperature of the substrate 12, T₀ is an initial temperature of the substrate 12 before the coolant stream is formed, a is a real-time lattice constant of the substrate 12, a₀ is an initial lattice constant of the substrate 12 before the coolant stream is formed, and α₁ is a thermal expansion coefficient of the substrate 12. This formula calculates the temperature of the substrate 12 based on changes in its lattice constant as measured through the diffraction data. By comparing the real-time lattice constant (a) of the substrate 12 with its initial lattice constant (a₀) before cooling, the difference is normalized using the initial lattice constant and the thermal expansion coefficient (α1), which is a known characteristic of the substrate 12. This calculation provides the real-time temperature (T) of the substrate 12 by correlating the changes in the lattice constant with the linear thermal expansion behavior of the substrate 12. This enables the method 100 to determine the temperature of the substrate 12 without requiring direct temperature sensors, making it possible to track thermal changes in real-time during cooling and warming cycles, using X-ray diffraction analysis.

Herein, the method 100 also includes determining the temperature of the thin film 14 to be T. That is, the method 100 involves determining the temperature of the thin film 14 to be the same as the temperature of the substrate 12, i.e. ‘T’. It may be understood, since the thin film 14 is formed on the substrate 12 (and is in direct contact with the substrate 12 in some embodiments), the thin film 14 may have the same temperature as the substrate 12. This determination is based on the principle that thermal expansion behavior of the substrate 12 directly correlates with the thermal behavior of the thin film 14. Therefore, after calculating real-time temperature of the substrate 12 using changes in its lattice constant and known thermal expansion coefficient, this temperature (T) is also assigned to the thin film 14.

In the present configuration, the controller is configured to determine the temperature of the substrate 12 by T=T₀+(a−a₀)/(a₀α₁) and determine the temperature of the thin film 14 to be T. The controller uses the changes in lattice constant of the substrate 12 to calculate real-time temperature of the substrate 12, based on the initial temperature and known thermal expansion behavior of the substrate 12. By normalizing the difference between the real-time lattice constant (a) and the initial lattice constant (a₀) using the thermal expansion coefficient (α1), the controller accurately determines the temperature (T) of the substrate 12. The controller is further configured to assign this calculated temperature (T) to the thin film 14, as the thin film 14 is formed directly on the substrate 12.

Further, in the present embodiments, the method 100 involves analyzing thermal behavior of the thin film 14 based on the temperature of the thin film 14. Herein, the thermal behavior of the thin film 14 includes at least one selected from the group consisting of thermal expansion, thermal contraction and structural phase transition. That is, once the temperature of the thin film 14 is determined to be the same as that of the substrate 12, the temperature data serve as a reference for analyzing how the thin film 14 responds to varying temperatures. By observing changes in the diffraction data collected during cooling and warming cycles, the thermal expansion and contraction behavior of the thin film 14 is determined based on temperature variations, specifically the predictable relationship between temperature and lattice constant changes in the thin film 14. Also, any structural phase transitions that occur within the thin film are analyzed as the temperature shifts. Structural phase transitions, such as changes in crystalline structure or magnetic properties, can be identified through variations in diffraction patterns. By monitoring the temperature at which these transitions occur, the structural properties and thermal behaviors of the thin film 14 can be determined.

Furthermore, as discussed in the preceding paragraphs, the substrate 12 includes magnesium oxide (MgO) and the thin film 14 includes chromium nitride (CrN). For purposes of this exemplary embodiment, the method 100 further includes analyzing an in-plane lattice constant of CrN, an out-of-plane lattice constant of CrN, or both. This analysis provides detailed information on the structural properties and thermal behavior of CrN when the substrate is MgO. By assessing the in-plane and out-of-plane lattice constants, it is possible to determine changes due to thermal expansion, contraction, or structural phase transitions in CrN. In the present exemplary embodiment, the method 100 uses the following parameters. Herein, T₀ is about 293 K, representing the initial temperature of the substrate 12 before the coolant stream ‘C’ is formed. Also, a₀ is about 4.21 Å, which corresponds to the initial lattice constant of the MgO substrate before cooling. Further, α₁ is about 9.84×10⁻⁶ K⁻¹, which is the thermal expansion coefficient of MgO. Also, in general, the thermal expansion coefficient of MgO (α1) has a constant value with regard to temperature, providing predictable changes in lattice constant of the substrate 12 as a function of temperature. This predictable expansion behavior allows for accurate temperature determination of the MgO substrate 12, which is used to infer the temperature of the CrN thin film 14. Thus, by analyzing both the in-plane and out-of-plane lattice constants of CrN during cooling and warming cycles, the method 100 can detect any thermal expansion, contraction, or phase transitions occurring in the thin film 14.

The present disclosure provides the X-ray diffractometer 200 capable of operating in two distinct modes, both heating and cooling, within atmospheric conditions. This configuration eliminates the need for complex vacuum systems and expensive temperature regulators. By providing a more accessible and cost-effective approach, the method 100 of the present disclosure allows for a wider range of experiments. The proposed method 100 and the X-ray diffractometer 200 can be employed for exploring complex physical phenomena such as thermal expansion, thermal contractions, and structural phase transition in materials of interest for advanced technological applications.

### Experimental Data

The teachings of the present disclosure were applied to the examination of structural phase transitions in thin films of chromium nitride (CrN). The results demonstrated not only the effectiveness of the proposed configuration but also its applicability in advancing understanding of complex material behaviors.

Bulk CrN has been well studied and its structural, electronic, and magnetic properties have been mostly determined [See: P. A. Bhobe, A. Chainani, M. Taguchi, T. Takeuchi, R. Eguchi, M. Matsunami, K. Ishizaka, Y. Takata, M. Oura, Y. Senba, H. Ohashi, Y. Nishino, M. Yabashi, K. Tamasaku, T. Ishikawa, K. Takenaka, H. Takagi, and S. Shin, Phys. Rev. Lett. 104, 236404 (2010); L. M. Corliss, N. Elliott, and J. M. Hastings, Phys. Rev. 117, 929 (1960); A. Filippetti and N. A. Hill, Phys. Rev. Lett. 85, 5166 (2000), incorporated herein by reference in their entirety]. For example, bulk CrN has rock salt crystal structure with paramagnetic (PM) phase at room temperature (RT), but undergoes a transition to an orthorhombic crystal structure with antiferromagnetic (aFM) phase below its Néel temperature (TN ˜270-285 K) [See: Corliss et al.; Filippetti et al.; B. U. Haq, K. Alam, M. B. Haider, A. M. Alsharari, S. Ullah, and S.-H. Kim, Phys. E Low-Dimens. Syst. Nanostructures 150, 115697 (2023), incorporated herein by reference in their entirety]. Magnetic stresses have been proposed as the key cause of the structural phase transition. Exfoliated layers of CrN films shows even more interesting electronic bonding and magnetic properties. The bandgap of CrN doped with oxygen can be varied from 0.07 to 3.56 eV, which is of high interest for optoelectronic and photovoltaic applications [See: W. Sanjo Kamoru, M. Baseer Haider, B. Ul Haq, S. H. Aleithan, A. M. Alsharari, S. Ullah, and K. Alam, Results Phys. 107387 (2024), incorporated herein by reference in its entirety].

However, in the published literature, it is difficult to reconcile disagreement about the electronic, magnetic, and structural properties of CrN thin films below its Néel temperature. In the published reports, CrN thin films have been grown by a variety of growth techniques such as molecular beam epitaxy (MBE) and radio frequency/direct current sputtering system with different Cr/N stoichiometric ratios on different kinds of substrates such as glass, sapphire, magnesium oxide (MgO), and silicon (Si). Some groups reported structural, electronic, and magnetic transitions and other groups did not observe these transitions [See: K. Alam, S. M. Disseler, W. D. Ratcliff, J. A. Borchers, R. Ponce-Pérez, G. H. Cocoletzi, N. Takeuchi, A. Foley, A. Richard, and D. C. Ingram, Phys. Rev. B 96, 104433 (2017); A. Garzon-Fontecha, H. A. Castillo, E. Restrepo-Parra, and W. De La Cruz, Surf. Coat. Technol. 334, 98 (2018); C. Constantin, M. B. Haider, D. Ingram, and A. Smith, Appl. Phys. Lett. 85, 6371 (2004); K. Inumaru, K. Koyama, N. Imo-oka, and S. Yamanaka, Phys. Rev. B 75, 054416 (2007); X. Y. Zhang, J. S. Chawla, R. P. Deng, and D. Gall, Phys. Rev. B 84, 073101 (2011); T. Rojas and S. E. Ulloa, Phys. Rev. B 96, 125203 (2017); K. Alam, R. Ponce-Pérez, K. Sun, A. Foley, N. Takeuchi, and A. R. Smith, J. Vac. Sci. Technol. Vac. Surf. Films 39, 063209 (2021); A. Ney, R. Rajaram, S. S. P. Parkin, T. Kammermeier, and S. Dhar, Appl. Phys. Lett. 89, 112504 (2006); R. Ponce-Pérez, K. Alam, G. H. Cocoletzi, N. Takeuchi, and A. R. Smith, Appl. Surf. Sci. 454, 350 (2018); K. Alam, M. B. Haider, M. F. Al-Kuhaili, K. A. Ziq, and B. U. Haq, Ceram. Int. 48, 17352 (2022), incorporated herein by reference in their entirety]. In a previous study, CrN grown by MBE on MgO(001) substrates show magnetic transition from PM in cubic phase at RT to aFM at low temperatures [See: Alam, Disseler et al.; Alam, Ponce-Pérez et al.; Ponce-Pérez, Alam et al,; K. Alam, K.-Y. Meng, R. Ponce-Pérez, G. H. Cocoletzi, N. Takeuchi, A. Foley, F. Yang, and A. R. Smith, J. Phys. Appl. Phys. 53, 125001 (2020), incorporated herein by reference in their entirety]. At low temperatures, the magnetic results were in agreement with the orthorhombic crystal structure. However, the reflection high energy electron diffraction (RHEED) experiment determined tetragonal/cubic crystal structure at the surface. The calculations showed that orthorhombic crystal structure is more stable compared to the tetragonal crystal, but the energy difference is so small that epitaxial constraints due to the substrate could offset it. One recent experiment on CrN thin films grown on glass and Si(001) substrates by radio frequency sputtering system showed an electronic transition from semiconductor at room temperature to either a metallic or semiconductor phase depending on the oxygen concentration in the films.

In another study, an extensive examination was conducted to explore a structural phase transition in CrN thin films grown on MgO(001) substrates using molecular beam epitaxy (MBE) [See: K. Alam, R. Ponce-Pérez, K. Sun, A. Foley, N. Takeuchi, and A. R. Smith, J. Vac. Sci. Technol. A 41, 053411 (2023), incorporated herein by reference in its entirety]. This exploration was undertaken through temperature-dependent x-ray diffraction analyses spanning from 203 K to 293 K. The findings of this investigation validate the effective functionality of the low-temperature X-ray diffractometer 200 proposed in the present disclosure. The X-ray diffractometer 200 holds promise for utilization in high quality teaching and research investigations.

In particular, in the present disclosure, a commercially available x-ray diffractometer, which was designed for a room temperature ambient pressure x-ray characterization of solids, was used. The diffractometer electronics was covered with water resistant material and only the sample holder was left to air. A partially insulated container for liquid nitrogen was taken. The container had a long flexible exhaust pipe. The pipe can be bent to aim it on the film for cooling. A stable, insulating base for the container was designed. A container was put under the sample stage to collect ice and water that drops from the sample. After filling the container with liquid nitrogen, its cold vent began coming out of the container on the exhaust pipe. Since the exhaust pipe was pointed on the sample, the cold vapor began cooling the films. The x-ray diffraction data of a specific peak, in a repeated mode, was recorded and saved for each spectrum. The CrN studied here was carefully grown on MgO(001) substrate in a custom designed MBE [See: W. Lin, A. Foley, K. Alam, K. Wang, Y. Liu, T. Chen, J. Pak, and A. R. Smith, Rev. Sci. Instrum. 85, 043702 (2014), incorporated herein by reference in its entirety]. Since the 002 peak of CrN and MgO are closer (with 2 degrees), so there was negligible temperature difference in temperatures when the two peaks are scanned. The data of the linear thermal expansion of MgO were used to determine the temperature of the sample. Then the temperature data were used to examine the thermal expansion of out-of-plane lattice constant of CrN. A sharp change in the out-of-plane lattice constant of CrN was noticed at the temperature which matched with the reported magneto-structural transition in CrN. The data were repeated a few times for cooling and warming cycles and every time the data were reproducible.

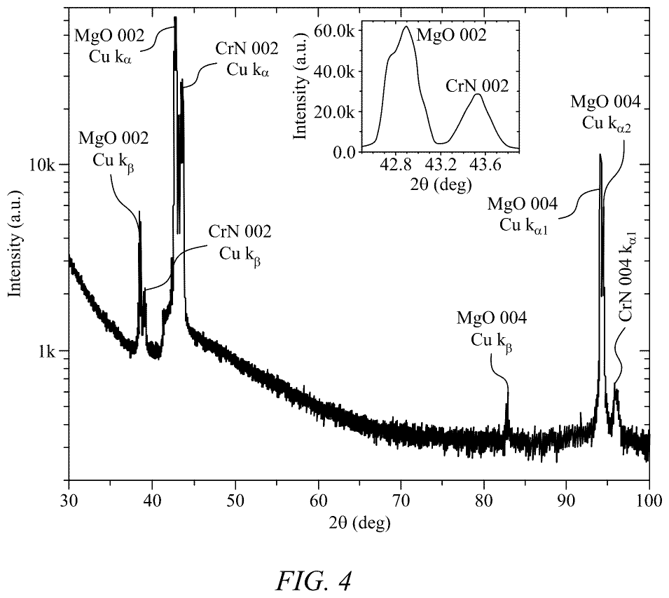

The X-ray diffraction (XRD) pattern of sample S45 is shown in FIG. 4. The X-ray beam consisted of three wavelengths k_{β}=1.3923 Å, k_{α1}=1.54059 Å, and k_{α2}=1.54439 Å. The wavelength of k_{α1} and k_{α2} were very close and could not be filtered out completely one wavelength from another by monochromators in commercially available XRD setups, but the intensity of k_{α1} was more than the intensity of k_{α2}. At small 2θ values (approximately less than 60°) the peak produced by k_{α2} is convoluted and appeared as a shoulder on the right side of the peaks produced by the k_{α1} wavelength, but at higher 2θ values the k_{α1} and k_{α2} produced separate peaks. The difference between k_{α1} and k_{β} wavelength was relatively large, but the monochromators did not filter out k_{β} completely from the X-ray beam. For small intensity peaks, the peak produced by k_{β} was negligibly small, but for high intensity peaks such as 002 peaks of MgO and CrN, the peak produced by k_{β} wavelength had significant intensity. The MgO peaks with the wavelength and 2θ values enclosed in parenthesis were 002 (k_{β}, 38.59°), 002 (k_{α1}, 42.90°), 004 (k_{α1}, 94.11°), and 004 (k_{α2}, 94.40°) and CrN peaks were 002 (k_{β}, 39.19°), 002 (k_{α1}, 43.54°) and 004 (k_{α1}, 95.92°). The MgO lattice constant was determined to be 4.213 Å, which was in agreement with the reported values of 4.21 Å in literature [See: O. Köksal and R. Pentcheva, Phys. Rev. B 103, 045135 (2021), incorporated herein by reference in its entirety].

The 002 peak of CrN appears at 2θ=43.54°. The peak location corresponds to out-of-plane lattice constant a_{⊥}=4.152 Å, which is in the range of the reported values of 4.13-4.17 Å [See: Constantin et al.; Ney et al.; D. Gall, C.-S. Shin, T. Spila, M. Odén, M. J. H. Senna, J. E. Greene, and I. Petrov, J. Appl. Phys. 91, 3589 (2002); M. Benkahoul, P. Robin, S. C. Gujrathi, L. Martinu, and J. E. Klemberg-Sapieha, Surf. Coat. Technol. 202, 3975 (2008), incorporated herein by reference in their entirety]. The lattice constants of the CrN and MgO in the sample are 4.213 Å and 4.152 Å, respectively. These lattice constants indicate a lattice mismatch

$$\frac{{a}_{CrN} - {a}_{MgO}}{{a}_{MgO}} \times 100 of 1.45 \% .$$

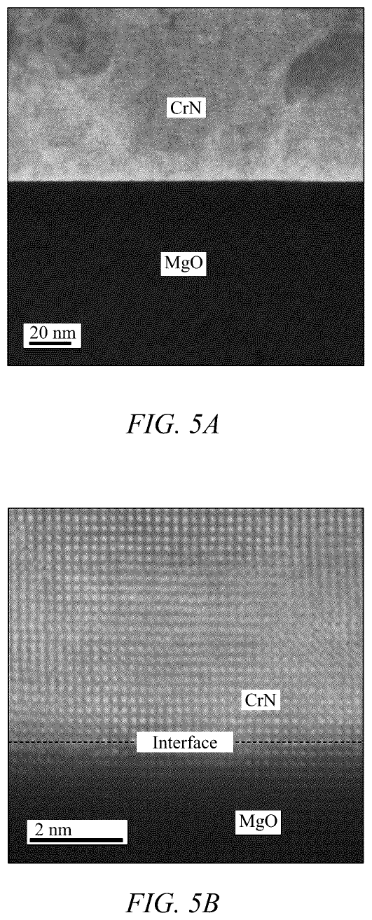

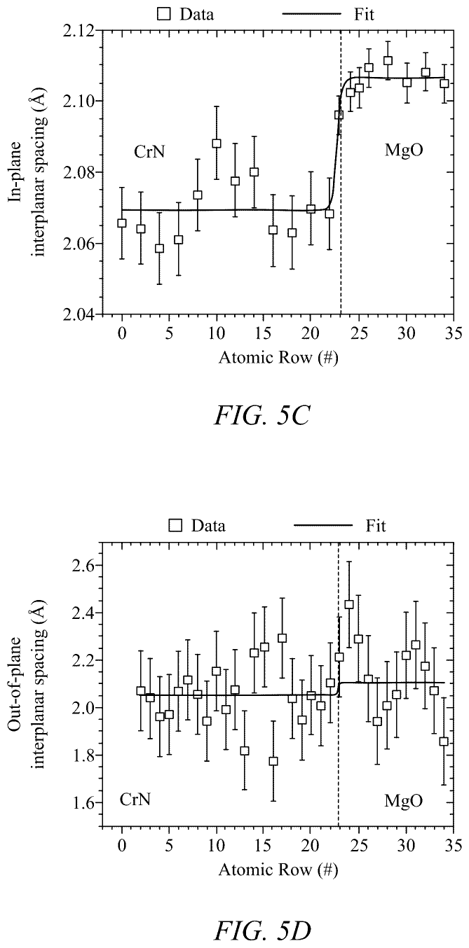

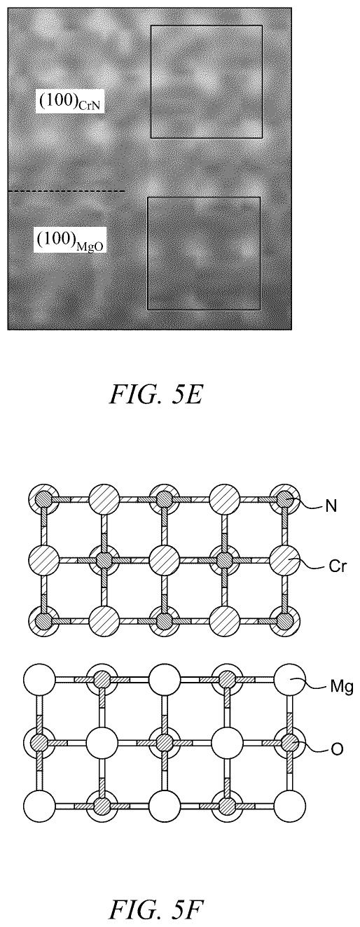

FIG. 5A illustrates a cross-sectional High-angle annular dark-field (HAADF) image of CrN/MgO(001) interface of S73 thin film at low magnification. The CrN layer is continuous with no cracks in the entire range scanned by the scanning transmission electron microscopy (STEM). The difference in the charge densities of CrN and MgO layers produces color contrast, and the CrN layer appears brighter compared to the MgO layer. Thickness of film S73 is 150 nm and of film S45 is 670 nm, but there is no noticeable difference in the magneto-structural transition temperature of CrN in this thickness range.

FIG. 5B illustrates an atomically resolved bright field image of CrN and MgO taken

along [100]_{CrN}. Due to the lattice 1.45% of mismatch between the CrN and MgO the first few CrN monolayers at the CrN/MgO interface are expected to have in-plane tensile strain. Using Van der Mervwe model [See: A. Kumar and A. Subramaniam, Appl. Surf. Sci. 275, 60 (2013), incorporated herein by reference in its entirety] for the layer by layer growth, the critical thickness for the CrN layer on MgO substrate is about one monolayer, so the dislocations such as edge dislocation may exist in the film, but have not been observed with the STEM in the scanned area. The in-plane strain was reduced with more growth, which can be observed by carefully counting the number of atomic rows at the top and bottom side of FIG. 5B.

For more quantitative analyses, the in-plane and out-of-plane interplanar spacing are plotted versus atomic rows from the interface in FIG. 5C and FIG. 5D, respectively. Boltzmann fits on both data sets reveal that the interface is at the 23rd row. Both data sets have been calibrated with the measured MgO lattice constant of 4.213 Å. The Boltzmann equation used for the fit is:

$$f = {c}_{MgO} + [ {c}_{CrN} - {c}_{MgO} ] / [ 1 + exp ( ( x - {x}_{0} ) / dx ) ] ,$$

where c_{CrN} and c_{MgO} represent the interplanar spacings of CrN and MgO, x₀ represents position of the interfacial layer, and dx is the slope parameter of the curve. This slope parameter dx does not correspond to the actual slope of the curve at the inflection point [See: K. Heusser, R. Heusser, J. Jordan, V. Urechie, A. Diedrich, and J. Tank, Front. Neurosci. 15, (2021), incorporated herein by reference in its entirety]. Fit parameters for the in-plane data set are c_{MgO}=2.107±0.002 Å, c_{CrN}=2.069±0.002 Å and x₀=22.79±0.37 layer. The CrN interplanar spacing corresponds to an in-plane lattice constant (2×c_{CrN}) of 4.139±0.004 Å, which matches with the lattice constant determined by XRD within the margin of error. On the out-of-plane data set, the fit is applied with the following parameters c_{MgO}=2.107±0.046 Å, c_{CrN}=2.053±0.030 Å and x₀=22.80±0.40 layer. The CrN interplanar spacing corresponds to out-of-plane lattice constant of 4.106±0.06 Å. The out-of-plane lattice constant of CrN is smaller than the in-plane lattice constant due to the in-plane tensile strain. From CrN lattice parameters, its Poisson's ratio ν=(in-plane strain)/(out-of-plane strain) is determined to be 0.283±0.003, which is in agreement with 0.258 [See: M. F. Yan and H. T. Chen, Comput. Mater. Sci. 88, 81 (2014), incorporated herein by reference in its entirety] and 0.28 [See: L. Cunha, M. Andritschky, K. Pischow, and Z. Wang, Thin Solid Films 355-356, 465 (1999), incorporated herein by reference in its entirety].

FIG. 5E illustrates a zoomed-in view of the CrN(100)/MgO(100) interface and FIG. 5F illustrates a corresponding model. The CrN lattice is epitaxial with the MgO lattice and Cr is bonded with O of the MgO at the interface as determined by the calculations in this study. The Cr, N, Mg, and O atoms are represented by balls and labeled in the drawings. Both CrN and MgO have rock salt crystal structure, a square unit cell of the (100) plane of the same size as the model is overlaid on the STEM image. This STEM measurement is consistent with the XRD results and reveals that the epitaxial relationship between CrN and MgO is [100]_{CrN}∥[100]_{MgO} and [001]_{CrN}∥[001]_{MgO}.

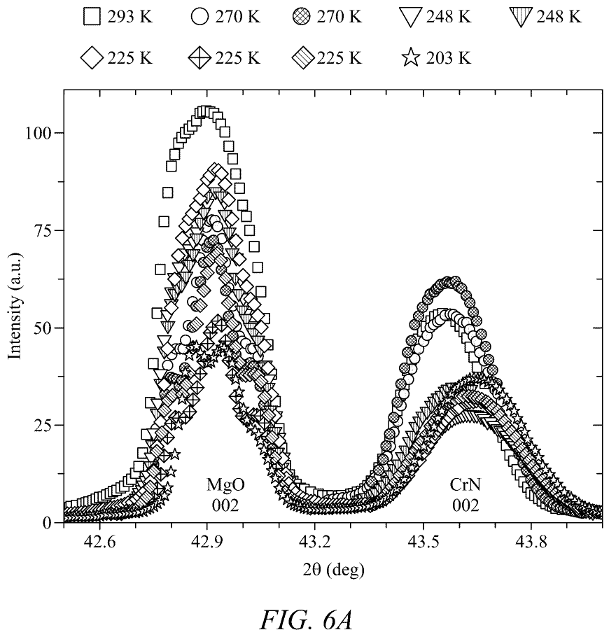

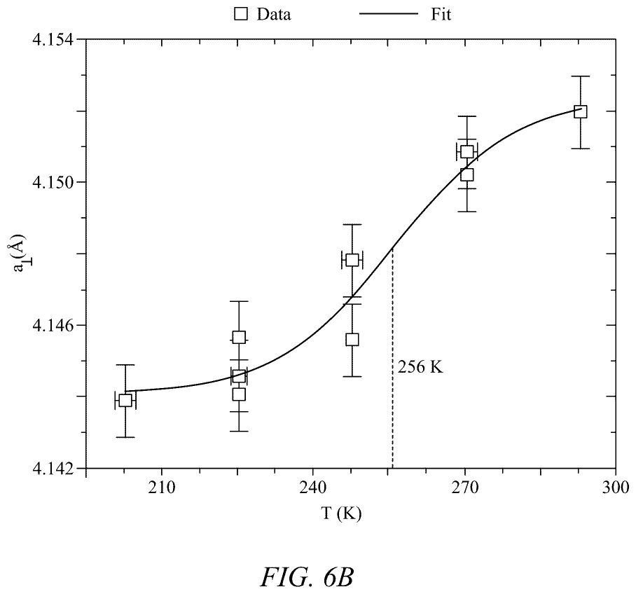

Further, the structural phase transition in CrN thin films is studied by VT-XRD experiments. Sample S45 was cooled down by flowing nitrogen vapor over the sample from 293 K to 203 K, and then warmed up by controlling the vapor flow. X-ray diffraction spectra of the sample was continuously recorded during both the cooling and warming cycle. FIG. 6A shows that during cooling, the 002 peaks of MgO and CrN shift to the right, and during warming these peaks move to the left representing contraction and expansion of the lattice constants. Since this experiment was not done under vacuum, the difference in intensities is likely due to the ice formation on the surface. The MgO lattice constant contracts linearly for the temperature range of this experiment [See: D. C. Harris, L. R. Cambrea, L. F. Johnson, R. T. Seaver, M. Baronowski, R. Gentilman, C. Scott Nordahl, T. Gattuso, S. Silberstein, P. Rogan, T. Hartnett, B. Zelinski, W. Sunne, E. Fest, W. Howard Poisl, C. B. Willingham, G. Turri, C. Warren, M. Bass, D. E. Zelmon, and S. M. Goodrich, J. Am. Ceram. Soc. 96, 3828 (2013), incorporated herein by reference in its entirety]. As a result, the temperature of the samples is readily determined using MgO data from this experiment and thermal expansion coefficient (α_{MgO}) of 9.84×10⁻⁶ K⁻¹ [See: O. Madelung, Semiconductors: Data Handbook (Springer Science & Business Media, 2004); L. Liu, K. Morita, T. S. Suzuki, and B.-N. Kim, J. Eur. Ceram. Soc. 41, 2096 (2021), incorporated herein by reference in their entirety] in equation

$$T ( K ) = 293 K + \frac{Δ a}{{a}_{0} {a}_{MgO}} .$$

However, the CrN peak position is found to not shift in a completely linear fashion over the range around the expected phase transition. This trend is observed in the CrN out-of-plane lattice constant (a_{⊥}) versus temperature data presented in Table I and in FIG. 6B where a_{⊥} is plotted versus temperature. A fit to the data is obtained by using Boltzmann equation:

$${a}_{⊥} ( T ) = 4.152 \mathring{A} - 0.008 \mathring{A} / [ 1 + exp ( ( T - {T}_{N} ) / Δ T ) ] ,$$

which gives a transition temperature of 256±6 K, which is lower than what has been reported for the CrN thin films studied by variable temperature reflection high energy electron diffraction and variable temperature neutron diffraction experiments. There are two possible reasons for the lower transition temperature observation. First, in this experiment the film temperature is determined from the linear thermal expansion of MgO; and second, the temperature equilibration time per step was not long enough. Nevertheless, the non-linear change in the out-of-plane lattice parameter is clear from the plot shown in FIG. 6B. On the other hand, assuming linear thermal expansion for the CrN, its thermal expansion coefficient (α_{CrN}) becomes 2.9×10⁻⁵ K⁻¹, which is 3-4× larger than reported values 0.75-1.06×10⁻⁵ K⁻¹ [See: Zhang et al.; G. C. A. M. Janssen, F. D. Tichelaar, and C. C. G. Visser, J. Appl. Phys. 100, 093512 (2006); L. Zhou, F. Körmann, D. Holec, M. Bartosik, B. Grabowski, J. Neugebauer, and P. H. Mayrhofer, Phys. Rev. B 90, 184102 (2014); R. Daniel, D. Holec, M. Bartosik, J. Keckes, and C. Mitterer, Acta Mater. 59, 6631 (2011), incorporated herein by reference in their entirety]. Similar transition in the c axis has been reported by Zieschang et al. [See: A.-M. Zieschang, J. D. Bocarsly, M. Dürrschnabel, H.-J. Kleebe, R. Seshadri, and B. Albert, Chem. Mater. 30, 1610 (2018), incorporated herein by reference in its entirety] for CrN nanoparticles.

TABLE I
Film temperature T versus CrN out-of-plane lattice constant

| T(K.) | 293.0 | 270.4 | 270.4 | 247.9 | 247.9 | 225.3 | 225.3 | 225.3 | 202.7 |
|---|---|---|---|---|---|---|---|---|---|
| a_{⊥}(Å) | 4.152 | 4.151 | 4.150 | 4.148 | 4.146 | 4.145 | 4.146 | 4.144 | 4.144 |

It may be noted that materials contract or expand by changing their temperature. On the atomic scale, in some materials, the distance between atoms increases or decreases linearly whereas other materials show non-linear contractions or expansions as function of temperature. Some materials exhibit phase transitions such as structural, electronic, and magnetic transitions as a function of temperature and some materials these transitions are coupled such as in chromium nitride. X-ray diffraction is one of the popular techniques used for understanding the crystal structure of these materials. However, mostly X-ray diffraction analysis need very expensive set-ups that require high vacuum and expensive temperature controllers.

The present disclosure provides the method 100 and the X-ray diffractometer 200, which simplify the study of structural transitions and thermal behaviors in thin films like CrN. By eliminating the need for expensive vacuum systems and temperature controllers, the proposed X-ray diffractometer 200 provides a cost-effective solution for advanced research. The ability of the X-ray diffractometer 200 to cool and heat samples in an open-air environment expands its applicability to a wide range of materials research while providing accurate data for detailed phase transition analysis. This configuration offers an affordable avenue for conducting high quality variable temperature analyses of materials, including nanoparticles and thin films. This approach derives sample temperature through linear thermal expansion information with no need for any temperature controller/sensors. The proposed apparatus stands poised to unravel intricate physical phenomena like thermal contraction, expansion, and structural phase transition in materials pivotal for cutting-edge technological advancements.

Next, further details of the hardware description of the computing environment according to exemplary embodiments is described with reference to FIG. 7. In FIG. 7, a controller 700 is described in which the controller 700 is a computing device which includes a CPU 701 which performs the processes described above/below. The process data and instructions may be stored in memory 702. These processes and instructions may also be stored on a storage medium disk 704 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 701, 703 and an operating system such as Microsoft Windows 7, Microsoft Windows 8, Microsoft Windows 10, UNIX, Solaris, LINUX, Apple MAC-OS, and other systems known to those skilled in the art.

The hardware elements in order to achieve the computing device may be realized by various circuitry elements, known to those skilled in the art. For example, CPU 701 or CPU 703 may be a Xenon or Core processor from Intel of America or an Opteron processor from AMD of America, or may be other processor types that would be recognized by one of ordinary skill in the art. Alternatively, the CPU 701, 703 may be implemented on an FPGA, ASIC, PLD or using discrete logic circuits, as one of ordinary skill in the art would recognize. Further, CPU 701, 703 may be implemented as multiple processors cooperatively working in parallel to perform the instructions of the inventive processes described above.

The computing device in FIG. 7 also includes a network controller 706, such as an Intel Ethernet PRO network interface card from Intel Corporation of America, for interfacing with network 760. As can be appreciated, the network 760 can be a public network, such as the Internet, or a private network such as an LAN or WAN network, or any combination thereof and can also include PSTN or ISDN sub-networks. The network 760 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 708, such as a NVIDIA GeForce GTX or Quadro graphics adaptor from NVIDIA Corporation of America for interfacing with display 710, such as a Hewlett Packard HPL2445w LCD monitor. A general purpose I/O interface 712 interfaces with a keyboard and/or mouse 714 as well as a touch screen panel 716 on or separate from display 710. General purpose I/O interface also connects to a variety of peripherals 718 including printers and scanners, such as an OfficeJet or DeskJet from Hewlett Packard.

A sound controller 720 is also provided in the computing device such as Sound Blaster X-Fi Titanium from Creative, to interface with speakers/microphone 722 thereby providing sounds and/or music.

The general purpose storage controller 724 connects the storage medium disk 704 with communication bus 726, which may be an ISA, EISA, VESA, PCI, or similar, for interconnecting all of the components of the computing device. A description of the general features and functionality of the display 710, keyboard and/or mouse 714, as well as the display controller 708, storage controller 724, network controller 706, sound controller 720, and general purpose I/O interface 712 is omitted herein for brevity as these features are known.

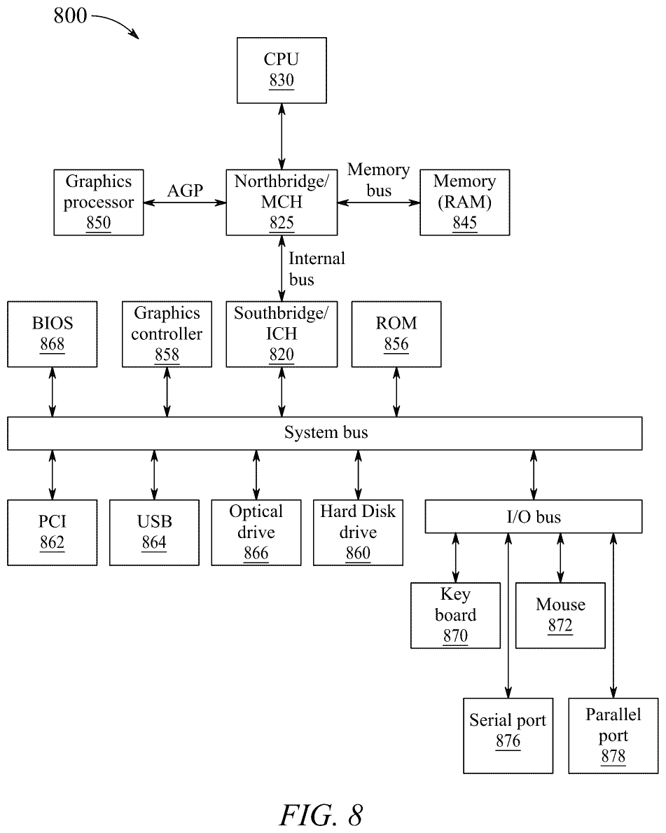

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 8.

FIG. 8 shows a schematic diagram of a data processing system, according to certain embodiments, for performing the functions of the exemplary embodiments. The data processing system is an example of a computer in which code or instructions implementing the processes of the illustrative embodiments may be located.

In FIG. 8, data processing system 800 employs a hub architecture including a north bridge and memory controller hub (NB/MCH) 825 and a south bridge and input/output (I/O) controller hub (SB/ICH) 820. The central processing unit (CPU) 830 is connected to NB/MCH 825. The NB/MCH 825 also connects to the memory 845 via a memory bus, and connects to the graphics processor 850 via an accelerated graphics port (AGP). The NB/MCH 825 also connects to the SB/ICH 820 via an internal bus (e.g., a unified media interface or a direct media interface). The CPU Processing unit 830 may contain one or more processors and even may be implemented using one or more heterogeneous processor systems.

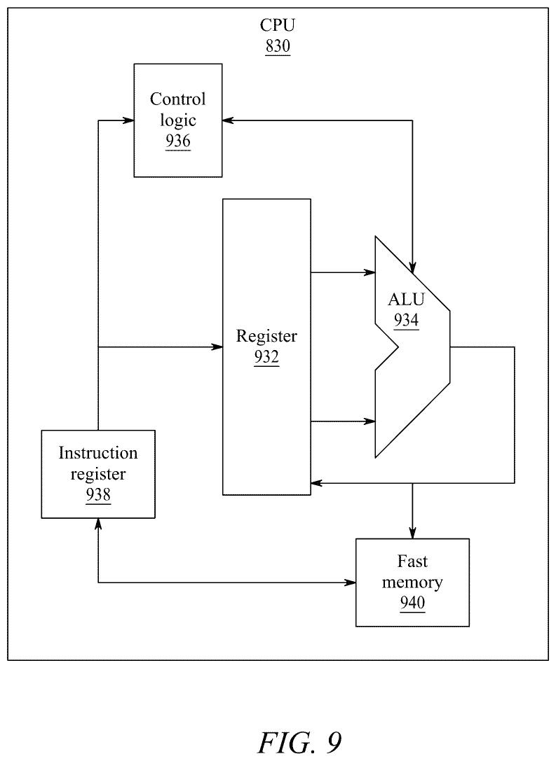

For example, FIG. 9 shows one implementation of CPU 830. In one implementation, the instruction register 938 retrieves instructions from the fast memory 940. At least part of these instructions are fetched from the instruction register 938 by the control logic 936 and interpreted according to the instruction set architecture of the CPU 830. Part of the instructions can also be directed to the register 932. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 934 that loads values from the register 932 and performs logical and mathematical operations on the loaded values according to the instructions. The results from these operations can be feedback into the register and/or stored in the fast memory 940. According to certain implementations, the instruction set architecture of the CPU 830 can use a reduced instruction set architecture, a complex instruction set architecture, a vector processor architecture, a very large instruction word architecture. Furthermore, the CPU 830 can be based on the Von Neuman model or the Harvard model. The CPU 830 can be a digital signal processor, an FPGA, an ASIC, a PLA, a PLD, or a CPLD. Further, the CPU 830 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 8, the data processing system 800 can include that the SB/ICH 820 is coupled through a system bus to an I/O Bus, a read only memory (ROM) 856, universal serial bus (USB) port 864, a flash binary input/output system (BIOS) 868, and a graphics controller 858. PCI/PCIe devices can also be coupled to SB/ICH 888 through a PCI bus 862.

The PCI devices may include, for example, Ethernet adapters, add-in cards, and PC cards for notebook computers. The Hard disk drive 860 and CD-ROM 866 can use, for example, an integrated drive electronics (IDE) or serial advanced technology attachment (SATA) interface. In one implementation the I/O bus can include a super I/O (SIO) device.

Further, the hard disk drive (HDD) 860 and optical drive 866 can also be coupled to the SB/ICH 820 through a system bus. In one implementation, a keyboard 870, a mouse 872, a parallel port 878, and a serial port 876 can be connected to the system bus through the I/O bus. Other peripherals and devices that can be connected to the SB/ICH 820 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

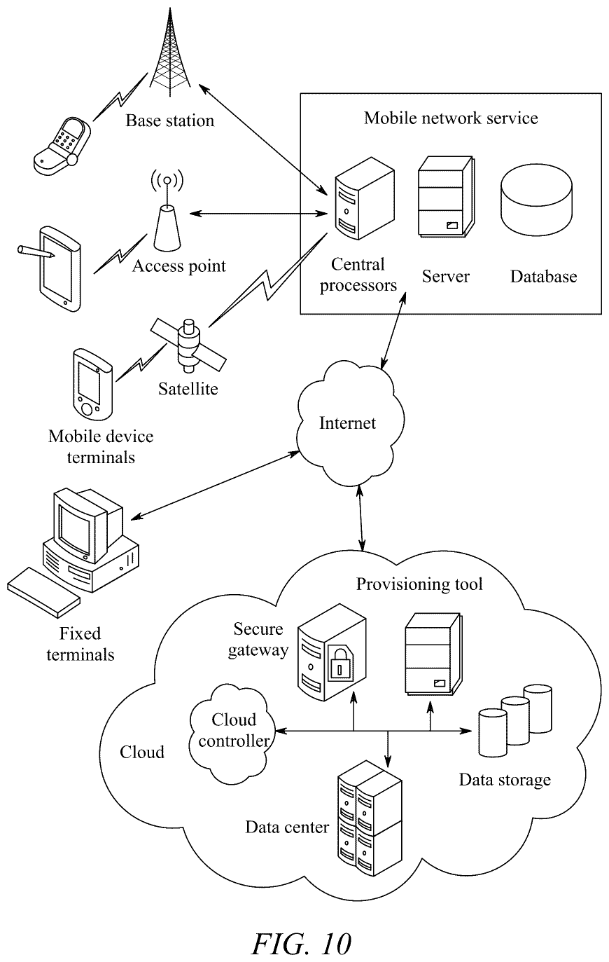

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 10, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

Numerous modifications and variations of the present disclosure are possible in light of the above teachings. It is therefore to be understood that within the scope of the appended claims, the invention may be practiced otherwise than as specifically described herein.

1. A method of X-ray characterization, comprising:
cooling a sample by:
delivering liquid nitrogen via a pipe to a sample stage of an X-ray diffractometer, and
discharging the liquid nitrogen from the pipe to form a coolant stream, the pipe having an outlet to orient a flow of the coolant stream at the sample on the sample stage, the sample comprising a substrate and a thin film formed on the substrate;
during the cooling, collecting diffraction data of the thin film and diffraction data of the substrate by a detector of the X-ray diffractometer; and
determining a temperature of the thin film based on the diffraction data of the substrate and thermal behavior of the substrate as a function of temperature, the thermal behavior of the substrate including thermal expansion, thermal contraction or both.

2. The method of claim 1, further comprising:
identifying a phase transition of the thin film based on the diffraction data of the thin film and the temperature of the thin film.

3. The method of claim 1, wherein:
the sample stage is at an atmospheric pressure.

4. The method of claim 3, wherein:
the X-ray diffractometer includes no temperature sensor that is configured to measure the temperature of the thin film or a temperature of the substrate.

5. The method of claim 4, wherein:
the X-ray diffractometer includes no temperature controller that is configured to maintain the sample stage or the sample at a specific temperature.

6. The method of claim 1, wherein:
the substrate has a linear thermal expansion behavior as a function of temperature.

7. The method of claim 6, wherein:
the substrate comprises magnesium oxide (MgO).

8. The method of claim 7, wherein:
the thin film has a linear thermal expansion behavior as a function of temperature.

9. The method of claim 7, wherein:
the thin film comprises chromium nitride (CrN).

10. The method of claim 1, wherein:
during the cooling, the sample is cooled by the coolant stream to a first temperature of 203 K to 273.15 K.

11. The method of claim 10, further comprising:
warming the sample to a second temperature above the first temperature by reducing a flow rate of the coolant stream delivered to the sample.

12. The method of claim 1, further comprising:
determining a temperature of the substrate by T=T₀+(a−a₀)/(a₀α₁), wherein
T is a real-time temperature of the substrate,
T₀ is an initial temperature of the substrate before the coolant stream is formed,
a is a real-time lattice constant of the substrate,
a₀ is an initial lattice constant of the substrate before the coolant stream is formed, and
a₁ is a thermal expansion coefficient of the substrate.

13. The method of claim 12, further comprising:
determining the temperature of the thin film to be T.

14. The method of claim 13, further comprising:
analyzing thermal behavior of the thin film based on the temperature of the thin film, the thermal behavior of the thin film including at least one selected from the group consisting of thermal expansion, thermal contraction and structural phase transition.

15. The method of claim 14, wherein the substrate comprises MgO, and the thin film comprises chromium nitride CrN, the method further comprising:
analyzing an in-plane lattice constant of CrN, an out-of-plane lattice constant of CrN or both.

16. The method of claim 15, wherein:
T₀ is about 293 K,
a₀ is about 4.21 Å, and
α₁ is about 9.84×10⁻⁶ K⁻¹.

17. The method of claim 12, wherein:
α₁ has a constant value with regard to temperature.

18. An X-ray diffractometer, comprising:
a sample stage configured to receive a sample;
an X-ray source configured to emit an X-ray beam directed at the sample;
a detector configured to receive a diffraction spectrum of the sample;
a pipe configured to deliver liquid nitrogen which is discharged from the pipe to form a coolant stream, the pipe having an outlet to orient a flow of the coolant stream at the sample on the sample stage; and
a base container configured to collect ice and water from the sample stage, wherein
the X-ray diffractometer includes no vacuum system configured to subject the sample stage to a vacuum condition so that the sample stage is at an atmospheric pressure,
the X-ray diffractometer includes no temperature sensor configured to measure temperature, and
the X-ray diffractometer includes no temperature controller configured to maintain the sample stage or the sample at a specific temperature.

19. The X-ray diffractometer of claim 18, further comprising:
a controller configured to determine a temperature of a thin film of the sample based on diffraction data of a substrate of the sample and thermal behavior of the substrate as a function of temperature, the thermal behavior of the substrate including thermal expansion, thermal contraction or both, the thin film formed over the substrate.

20. The X-ray diffractometer of claim 19, wherein:
the controller is configured to determine a temperature of the substrate by T=T₀+(a−a₀)/(a₀α₁) and determine the temperature of the thin film to be T, wherein
T is a real-time temperature of the substrate,
T₀ is an initial temperature of the substrate before the coolant stream is formed,
a is a real-time lattice constant of the substrate,
a₀ is an initial lattice constant of the substrate before the coolant stream is formed, and
α₁ is a thermal expansion coefficient of the substrate.
